(19) United States
(12) Patent Application Publication
(10) Pub. No.: US 2020/0005215 A1
(43) Pub. Date: Jan. 2, 2020

(54) COMPUTATIONAL ALIGNMENT OF HETEROGENOUS DATASETS TO GENERATE ACTIONABLE OUTPUT

(71) Applicant: Microsoft Technology Licensing, LLC, Redmond, WA (US)

(72) Inventors: PAN WU, Sunnyvale, CA (US); ZHAOYING HAN, San Jose, CA (US)

(73) Assignee: Microsoft Technology Licensing, LLC, Redmond, WA (US)

(21) Appl. No.: 16/020,954

(22) Filed: Jun. 27, 2018

(51) Int. Cl. G06Q 10/06; G06F 17/30

(52) U.S. Cl. CPC G06Q 10/063112; G06F 17/30572; G06F 17/3053; G06Q 10/063118

(57) ABSTRACT

Technologies for calculating a score based on a computational alignment of heterogenous datasets are provided. The disclosed techniques include determining job category data based on a member interaction with a management system, where the member interaction results in first output; pairing a member data record obtained from an online system with each job record in a group of job records obtained from the management system to produce a set of member-job pairs, where the group of job records is determined based on the job category data; calculating an aggregate alignment score over all of the member-job pairs using member skills data extracted from the member data record and job skills data extracted from the group of job records, where the aggregate alignment score is a measure of a mismatch between the member skills data and the job skills data; based on the alignment score, generating second output that replaces or modifies or supplements the first output with output that is actionable to address the mismatch between the member skills data and the job skills data.

### TECHNICAL FIELD

The present disclosure relates to networks that are processed by data processing systems, and more particularly to computer software that computationally aligns heterogenous datasets obtained from a networked system, where data records in the datasets are in a one to many relationship, in order to produce actionable output.

### BACKGROUND

Online systems can be used to match end user data with opportunity data. Some online systems can generate recommendations as to next opportunities to be considered by an end user, such as job opportunities. These recommendations are based on a one-to-one matching of information that is associated with the particular end user with information that is associated with a particular opportunity.

A limitation of existing opportunity recommendation technologies is that the opportunities are identified using a one to one matching approach. That is, comparisons are made by analyzing the similarities between an individual member data record and an individual opportunity data record. Another limitation of the existing technologies is that they are biased to look for similarities, rather than differences, between the individual data records being matched. As a result, existing systems are not effective when there are substantial differences between the member data record and the opportunity data record. Moreover, existing approaches do not measure the degree to which a particular member's data matches opportunity data across an entire group or category of opportunities.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A is a flow diagram that depicts a process for generating actionable output based on a computational alignment of heterogenous datasets using data records that are in a one-to-many relationship, in an embodiment;

FIG. 1B is a block diagram that depicts an example software-based system for interfacing with multiple different data sources to produce actionable output based on a computational alignment of heterogenous datasets, in an embodiment;

FIG. 1C is a block diagram of a networked computing system in which software for generating actionable output based on a computational alignment of heterogenous datasets using data records that are in a one to many relationship may be implemented, in an embodiment;

FIG. 2 is flow diagram that depicts a process for computationally aligning heterogenous datasets using data records that are in a one to many relationship to produce actionable output, in an embodiment;

FIG. 3 is an example entity relationship diagram showing a member data record having a one to many relationship with opportunity data records, and includes examples of skills data within a member data record and skills data within an opportunity data record, and includes examples of sources of skills data within an opportunity data record, in an embodiment;

FIGS. 4A, 4B, and 4C are screen captures of examples of actionable output, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A technical limitation of the existing opportunity recommendation software products is that they disregard pairs of data records that have low matching scores. This is because the existing products rely on the assumption that a high degree of similarity is a strong indicator of a good match. However, in a networked system, data records can be manipulated, compromised due to hacking, or even purposefully generated or modified to achieve a desired result. Because similarity-based matching scores can be artificially enhanced or purposefully engineered, the matches that are produced can be inaccurate and unreliable.

As disclosed herein, the manner in which existing opportunity recommendation systems perform matching is improved by adding technology that implements a particular approach to a computational matching process that operates on heterogenous data records in a one-to-many relationship. The disclosed approaches do not rely on a high degree of similarity as a determinant of a good match, although the disclosed approaches can be used in conjunction with or as an alternative to other approaches that do so.

The disclosed approaches improve the process of generating opportunity recommendations for users of an online system. In one particular application, the disclosed approaches improve the integration of an online job posting service with an online platform, such as the LINKEDIN professional social network, by identifying job opportunities in a job category (such as a particular industry) even when the opportunities are not strongly aligned with the current skill set of a member of the online platform.

The disclosed approaches produce actionable output that is driven by the computed measure of alignment. In an embodiment, the disclosed techniques are implemented as part of a programmable interface between a management system, such as an opportunity listing service, and an online system that has or uses a connection graph, such as a professional social network. In other embodiments, the disclosed approaches are implemented entirely within the online system or entirely within the management system.

In one approach, a computing system determines job category data based on a member interaction with a management system. The member interaction results in first output, such as search results or a first set of recommended opportunities. The computing system determines a group of job records based on the job category data. The computing system pairs a member data record obtained from an online system with each job record in the group of job records obtained from the management system to produce a set of member-job pairs. The computing system calculates an aggregate alignment score over all of the member-job pairs using member skills data extracted from the member data record and job skills data extracted from the group of job records. The aggregate alignment score is a measure of a match or a mismatch between the member skills data and the job skills data. Based on the aggregate alignment score, the computing system generates second output that replaces or modifies or supplements the first output with output that is actionable to address the mismatch between the member skills data and the job skills data.

Generation of Actionable Output Based on Aggregate Alignment Score Measure

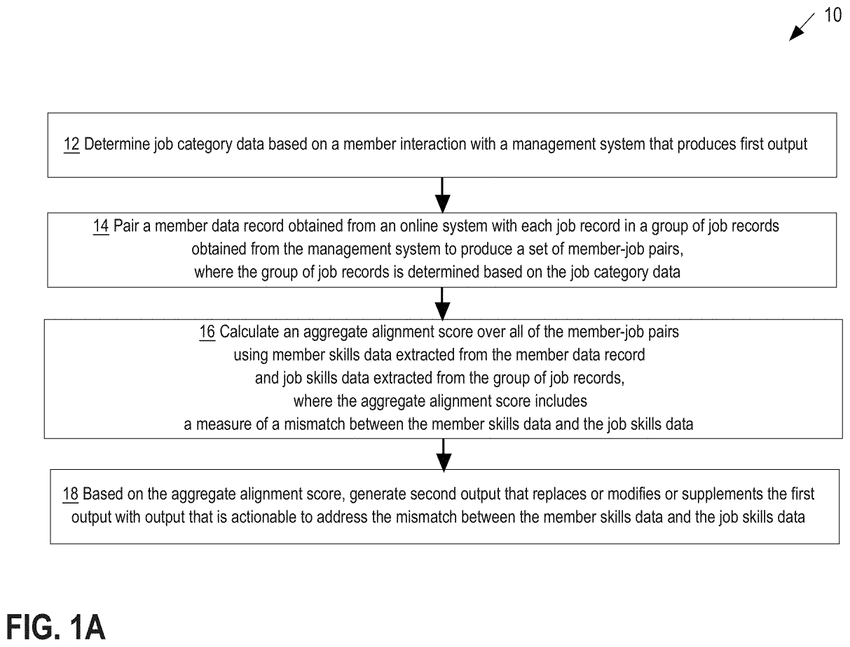

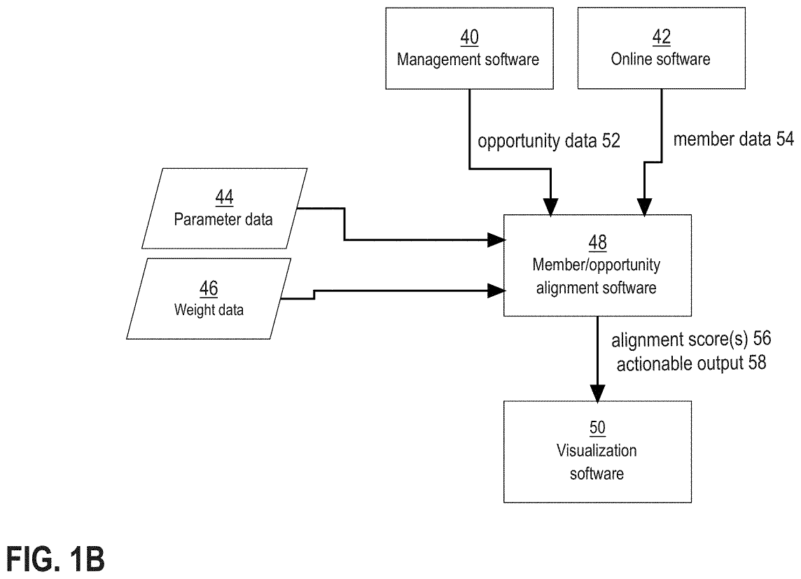

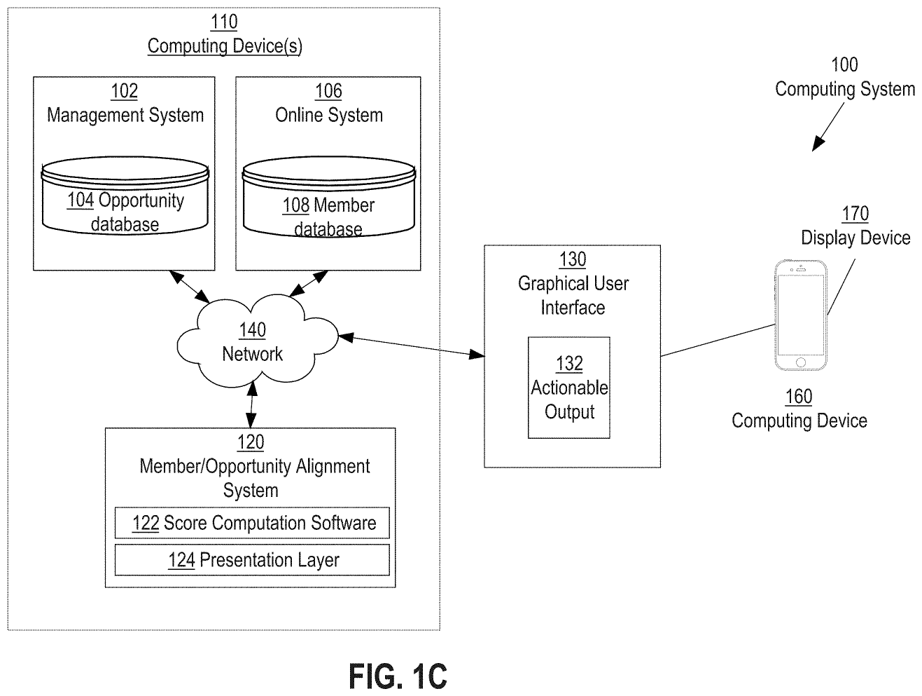

FIG. 1A is a flow diagram that depicts a process 10 that is performed by one or more components of a computing system 100, shown in FIGS. 1B and 1C, described below, in an embodiment. In some embodiments, portions of process 10 are performed by member/opportunity alignment software 48 and visualization software 50, shown in FIG. 1B, described below. In some embodiments, member/opportunity alignment software 48 is a component of score computation software 122 and visualization software 50 is a component of presentation layer 124, of member/opportunity alignment system 120, shown in FIG. 1C. Portions of process 10 may be performed by a single entity or program or by multiple entities or programs, including for example a browser plug-in and a remote server.

The operations of the process as shown in FIG. 1A are implemented using processor-executable instructions that are stored in computer memory. For purposes of providing a clear example, the operations of FIG. 1A are described as performed by computing device(s) 110, 160, which may be individually or collectively referred to simply as a ‘computing system.’

In operation 12, process 10 determines opportunity category data. In the described use case, opportunity category data includes job category data. Process 10 determines the job category data based on a member interaction with a management system, such as a job listing service, which produces first output. Examples of job category data include industry names, scientific and technical disciplines, and job titles. Process 10 uses the job category data to determine a group of job records to be aligned with member data.

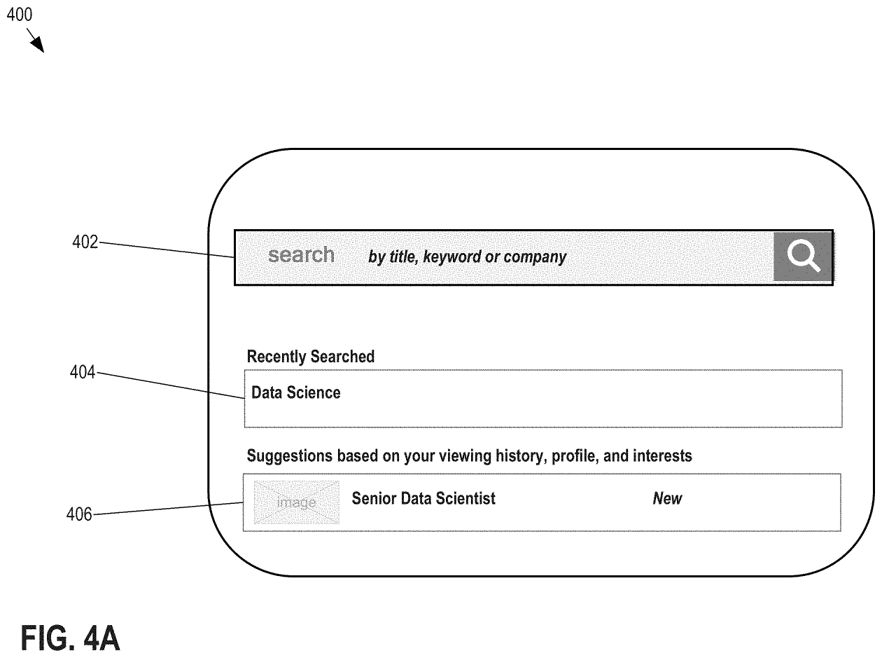

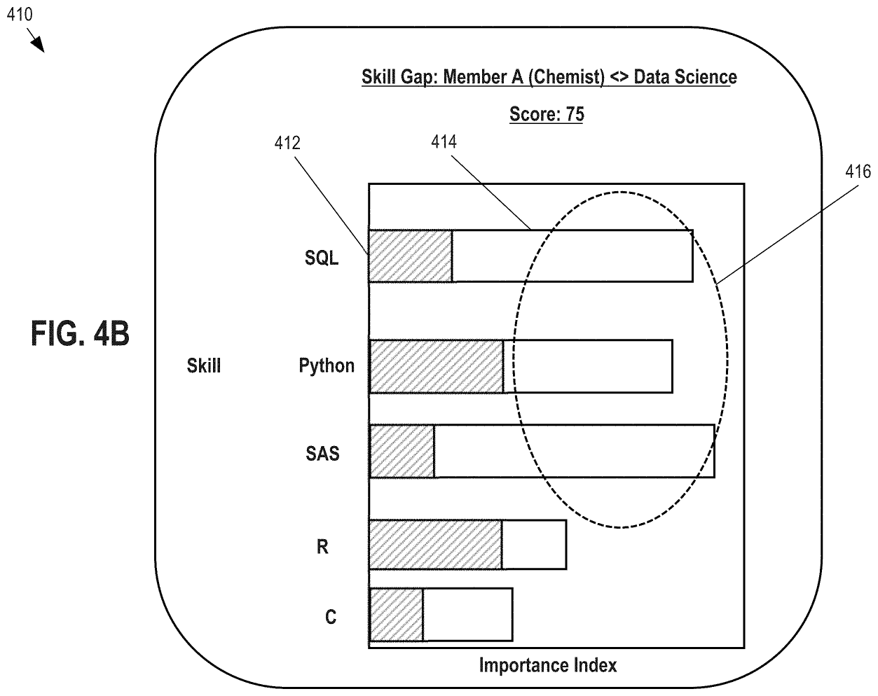

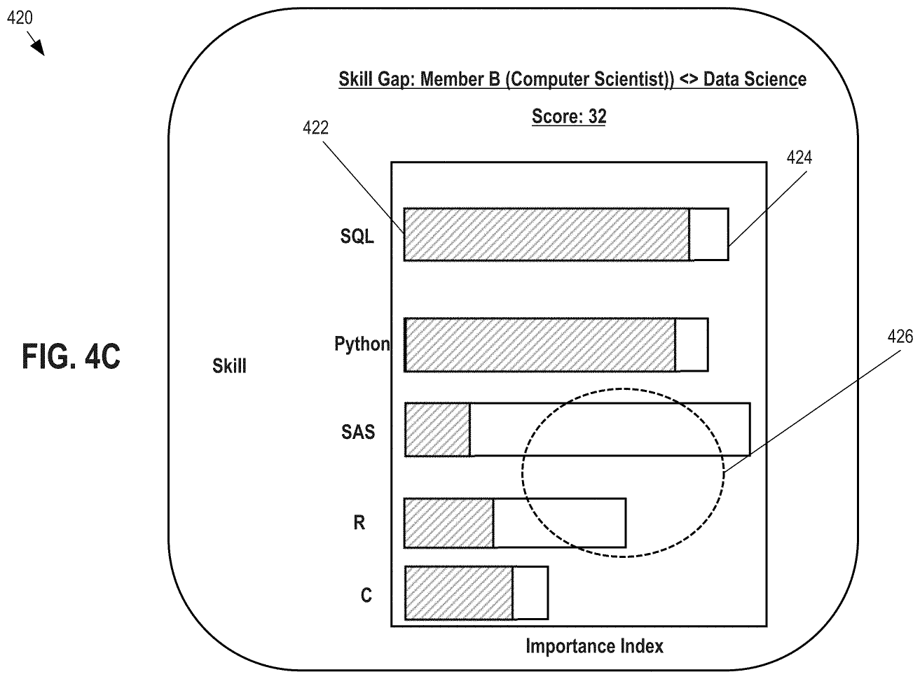

Examples of member interactions are shown in FIG. 4A, described below, and include a member inputting a keyword into a search box, or a member selecting a job category name from a list of job categories, or a member viewing a search result, such as a job posting in a particular job category. Other examples of member interactions with a management system include a history of the member's viewing, searching, or selecting activity. Examples of first output are shown in FIG. 4A, and include search results, recommendations made based on one to one comparisons between member data and job data for a particular job record, searching history, viewing history.

In operation 14, process 10 pairs a member data record obtained from an online system with each job record in a group of job records obtained from the management system, to produce a set of member-job pairs. The group of job records is determined based on the job category data obtained in operation 12. Operation 14 determines the member data record to pair with the job records in the group of job records based on member account data or login information associated with the member interaction that is detected in operation 12.

In one illustration, if operation 12 determines that a member M of online software 42 conducted a search in a management software 40, such as an online job posting service, using the search term, “data science,” then operation 12 may determine that job category data=“data scientist.” Operation 14, then, executes a search query on, for example, opportunity database 104, to identify job records that correspond to the job category of “data scientist.” Operation 14 then pairs the member data record with each of the job records in the “data scientist” job category. To do this, operation 14 instantiates a data structure, such as a tuple, with the member identifier (ID) of the member data record and the job ID of the job data record. An example of a tuple that pairs a member record with each of a plurality of job records associated with job category data is: [(M1, J1), (M1,J2), (M1,J3)], where M1 is the member ID and J1, J2, J3 are the job IDs of each of the job records in the job category.

In operation 16, process 10 calculates an aggregate alignment score over all of the member-job pairs generated in operation 14. To do this, process 10 compares member skills data extracted from the member data record with job skills data extracted from the group of job records. Process 10 uses meta data extracted from the member data record to locate member skills data within the member data record.

The member skills data includes structured data, such as pre-defined skill names that are stored in the member data record after having been selected from a pull-down list, for example. The member skills data also includes unstructured data, such as sentences and paragraphs that describe the member's work experience. A data extraction and standardization process operates on both the structured data and the unstructured data to produce a text-based list of member skills data, where each item in the list corresponds to a skill extracted from the member data record. The data extraction and standardization process is performed outside of process 10 in some embodiments, such that process 10 simply receives the output of the data extraction and standardization process.

Similarly, process 10 uses meta data extracted from the job data record to locate job skills data within the job data record. The job skills data includes structured data, such as pre-defined skill names that are stored in the job data record after having been selected from a pull-down list, for example. The job skills data also includes unstructured data, such as sentences and paragraphs that describe the job's requirements and responsibilities. A data extraction and standardization process operates on both the structured data and the unstructured data to produce a text-based list of job skills data, where each item in the list corresponds to a skill extracted from the job data record. The data extraction and standardization process is performed outside of process 10 in some embodiments, such that process 10 simply receives the output of the data extraction and standardization process.

Operation 16 computes the aggregate alignment score, which includes a measure of a mismatch between the member skills data and the job skills data. To do this, operation 16 tallies, for each skill in the job skills data, a count of a number of times the skill appears in the job skills data. The count of the number of occurrences of the skill in the job skills data is used to determine a weight value. Skills that have a higher number of occurrences in the job skills data have a higher weight value. The weight value is further adjusted if the skill is found in the member skills data, in some embodiments.

Operation 16 then determines, for each skill in the job skills data, whether the skill is present in the member skills data and assigns a data value to a skill possessed indicator. In an embodiment, the skill possessed indicator is binary: a value of 0 indicates that the member does not possess the skill, and a value of 1 indicates that the member possesses the skill. In other embodiments, fractional values between 0 and 1 are used as an indicator of a level of confidence in the determination that the skill is or is not possessed by the member.

To arrive at the aggregate alignment score, operation 16 computes a ratio in which the numerator is a data value that indicates a degree to which the member possesses the skills in the job skills data for the group of job records determined by the job category data, and the denominator is a data value that indicates a weighted average of all of the skills considered in the comparison. Skills not possessed by the member are included in the computation of the denominator and are not included in the computation of the numerator.

Operation 18 uses the aggregate alignment score to generate second output that replaces or modifies or supplements the first output, produced in operation 12, with output that is actionable to address the mismatch between the member skills data and the job skills data. Examples of second output are shown in FIGS. 4B and 4C, described below. In an embodiment, generating the second output includes causing a computing device or a display device to display a digital presentation of the second output.

Examples of digital presentations include interactive graphical user interface (GUI) elements that can be displayed on a display screen or included in an electronic message, such as a push message, an email message, voice-based output generated by text-to-speech (TTS) software, or another form of electronic communication. In one approach, process 10 generates a visualization of the second output and transmits (or makes available) the visualization to the management system through an API function, and then the management system incorporates the visualization into a digital presentation.

Member/Opportunity Alignment Software

FIG. 1B is a block diagram that depicts an example system for providing an interface between a management system and an online system, in an embodiment. The software-based components of the system of FIG. 1B include management software 40, online software 42, member/opportunity alignment software 48, visualization software 50, parameter data 44, and weight data 46.

Management software 40 is software that stores and manages skills data related to opportunities, such as a job listing service that provides a searchable database of job postings. An example of management software 40 is the “Jobs” component of the LINKEDIN mobile device software application, provided by LinkedIn Corporation of Sunnyvale, Calif. Other examples of management software 40 include other job listing services, such as INDEED, MONSTER, and CRAIGSLIST.

Users of management software 40 may or may not be registered in the online software 42. In some embodiments, registered users of online software 42 are also, automatically, registered users of management software 40. In other embodiments, management software 40 includes a separate registration process. In those other embodiments, a portion of member/opportunity alignment system 120 creates and stores, in an electronic file or a mapping table, for example, a mapping that links the member registration data stored in online software 42 with the member registration data stored in management software 40, to facilitate the exchange of data between the two systems.

Online software 42 is software that is designed to provide an online networking service for its members, such as a professional networking service or an online social network service. End users become members of online software 42 through a registration process that includes establishing a user account identifier, password, and online profile. An example of online software 42 is the online professional social network service known as LINKEDIN, provided by LinkedIn Corporation of Sunnyvale, Calif.

Member/opportunity alignment system 120 provides an interface through which a management system 102 and an online system 106 bidirectionally communicate data and/or computer instructions to one another. Member/opportunity alignment software 48 is operably coupled to management software 40 and online software 42, such as through network 140 shown in FIG. 1C, described below.

Member/opportunity alignment software 48 receives opportunity data 52 from management software 40 as a result of a data extraction and standardization process, which extracts the desired data and meta information from management software 40 and uses standardization rules to format and store the extracted data in an electronic file. The data extraction and standardization processes disclosed herein are implemented using computer code that is written in a programming language, such as Python.

Opportunity data 52 includes job records that contain job skills data. In some embodiments, opportunity data 52 also includes opportunity activity data. Opportunity activity data includes data indicative of the member's interactions with management software 40, which may be collected, with the member's permission or pursuant to a privacy policy, using cookies or other similar methods. Examples of opportunity activity data include search history data, including keywords used in online searches performed by the member, and view history data, including data indicative of job records viewed by the member within management software 40.

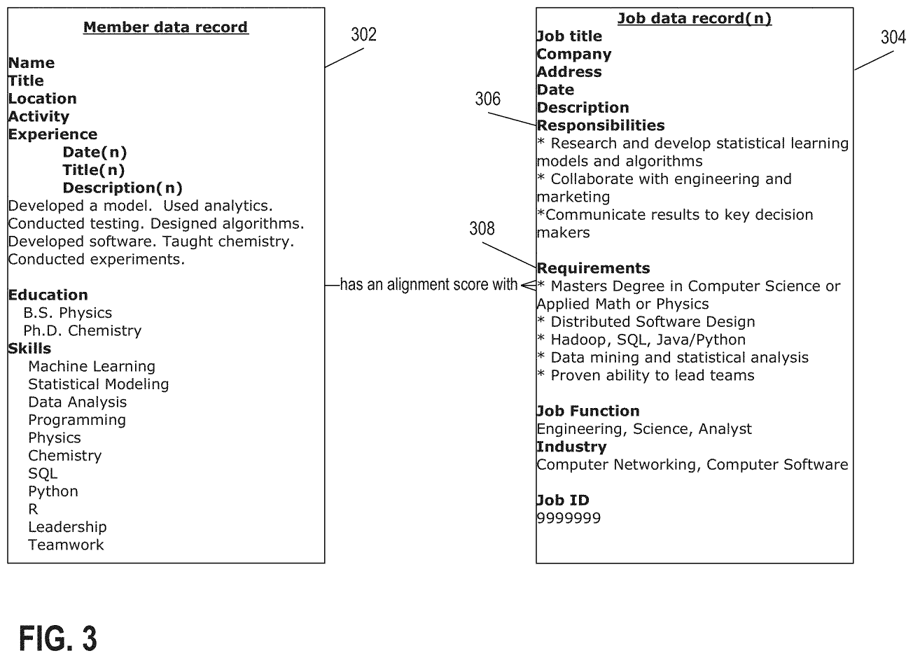

Opportunity data 52 may be an electronic data file that includes text-based data labeled with semantic tags, in an embodiment. For example, opportunity data 52 is created using JSON (JavaScript Object Notation), XML (Extensible Markup Language), or HTML (Hypertext Markup Language), in various embodiments. The semantic tags are, for example, meta tags, which are determined and applied according to a schema that is implemented by the data extraction and standardization process. Thus, the semantic tags are defined according to the requirements of a particular design or implementation of computing system 100. An example of opportunity data 52 is shown in FIG. 3, described below. As shown in FIG. 3 and described in more detail below, opportunity data 52 includes structured data and unstructured data, as well as meta data, in an embodiment.

Member/opportunity alignment software 48 receives member data 54 from online software 42 as a result of another data extraction and standardization process, which extracts the desired data and meta information from online software 42 and uses standardization rules to format and store the extracted data in an electronic file. The opportunity data 52 and member data 54 are heterogenous data sets; that is, the schema used by online software 42 is different from the schema used by management software 40. Thus, although it may be implemented using similar computer code, the data extraction and standardization process used to extract information from online software 42 is different than the data extraction and standardization process used to extract information from management software 40.

Member data 54 includes member records that contain member skills data. In some embodiments, member data 54 also includes member activity data. Member activity data includes data indicative of the member's interactions with online software 42, which may be collected, with the member's permission or pursuant to a privacy policy, using cookies or other similar methods. Examples of member activity data include search history data, including keywords used in online searches performed by the member, and view history data, including data indicative of member records viewed by the member within online software 42.

In embodiments in which member/opportunity alignment software 48 has access to activity data collected by either or both of management software 40 and online software 42 using approved methods, member/opportunity alignment software 48 uses the activity data to determine job category data, described above.

Member data 54 may be an electronic data file that includes text-based data labeled with semantic tags, in an embodiment. For example, member data 54 is created using JSON (JavaScript Object Notation), XML (Extensible Markup Language), or HTML (Hypertext Markup Language), in various embodiments. The semantic tags are, for example, meta tags, which are determined and applied according to a schema that is implemented by the applicable data extraction and standardization process. Thus, the semantic tags are defined according to the requirements of a particular design or implementation of computing system 100. An example of member data 54 is shown in FIG. 3, described below. As shown in FIG. 3, described below, member data 54 includes structured data and unstructured data, as well as meta data, in an embodiment.

Parameter data 44 is attribute data that is associated with associated with job skills data. Parameter data 44 is adjustable programmatically or by user input, and may be stored in or referenced by opportunity data 52. Examples of parameter data 44 include threshold data values that control the number of skills extracted from the job skills data that are actually used to perform the comparison with member skills data. Parameter data 44 is used by member/opportunity alignment software 48 to determine, for example, a subset of the most important skills extracted from the job skills data and use only that subset of most important skills to compute the aggregate alignment score. In some embodiments, parameter data 44 includes an adjustable matching parameter that is used by member/opportunity alignment software 48 to determine whether a member skill matches a job skill. For example, the adjustable matching parameter can be a threshold confidence value that has to be met or exceeded in order for the member skill and the job skill to be considered a match.

Weight data 46 is attribute data that is associated with job skills data and/or member skills data. Weight data is adjustable programmatically or by user input, and may be stored in or referenced by member data 54 and/or opportunity data 52. Examples of weight data 46 are numerical values that represent the relative importance of a particular skill in comparison to other skills in the job skills data or the member skills data, as the case may be. Weight data 46 is adjustable based on, for example, frequency of occurrence of a skill or strength of similarity between a job skill and a member skill.

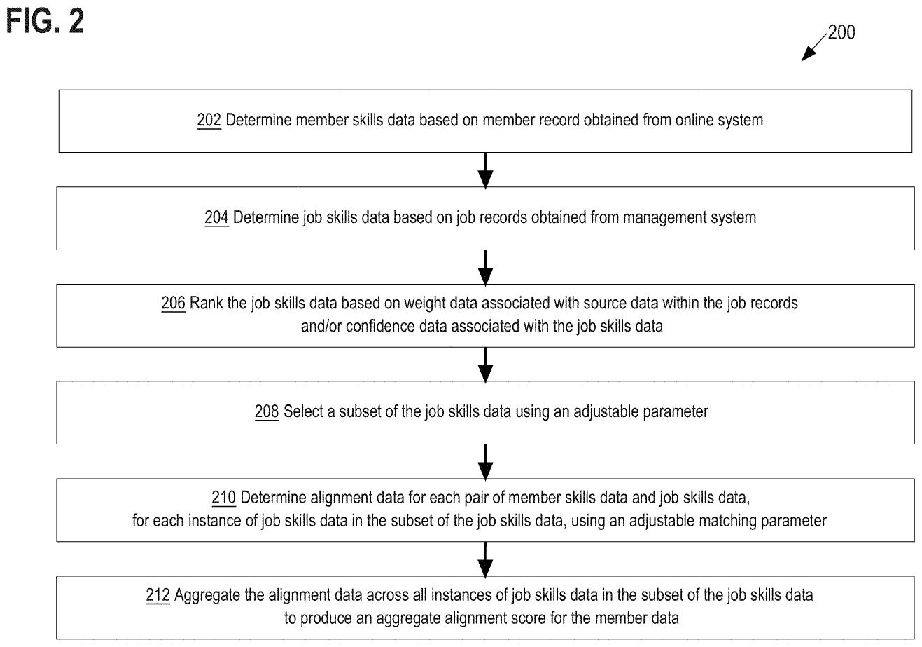

Member/opportunity alignment software 48 executes computer instructions that implement the processes shown in FIG. 1A, described above, and FIG. 2, described below, in an embodiment. Using opportunity data 52 and member data 54 as inputs, member/opportunity alignment software 48 executes the disclosed computational methods in accordance with the parameter data 44 and weight data 46 to produce alignment score(s) 56 and actionable output 58. Alignment score(s) 56 include aggregate alignment scores as shown and described herein. Actionable output 58 includes second output produced by process 10, alone or in combination with first output of process 10, in an embodiment. Member/opportunity alignment software 48 transmits or otherwise makes available alignment score(s) 56 and actionable output 58 to visualization software 50.

Visualization software 50 produces a visualization that includes at least the actionable output 58, which may include alignment score(s) 56. Example visualizations are shown in FIGS. 4B and 4C, described below. Visualization software 50 may be implemented within management software 40 or within online software 42 or within another software application (such as messaging software), or may be implemented as a separate module as shown in FIG. 1B.

### Networked System Example

FIG. 1C is a block diagram of a networked computing system in which member/opportunity alignment software may be implemented, for example as part of an interface between management software and online software, or as part of management software, or as part of online software.

Computing system 100 includes at least computing device(s) 110, computing device 160, and display device 170, which are communicatively coupled to an electronic communications network 140. Implemented in the devices 110, 160, 170 using computer software, hardware, or software and hardware, are combinations of automated functionality embodied in computer programming code, data structures, and digital data, which are represented schematically in FIG. 1 as management system 102, opportunity database 104, online system 106, member database 108, member/opportunity alignment system 120, graphical user interface 130, actionable output 132. System as used in this disclosure may refer to a single computer or network of computers and/or other devices. Computing device as used in this disclosure may refer to a computer or any other electronic device that is equipped with a processor.

Although computing system 100 may be implemented with any number N (where N is a positive integer) of management system 102, opportunity database 104, online system 106, member database 108, member/opportunity alignment system 120, graphical user interface 130, computing devices 110, display devices 170 and computing devices 160, respectively, in this disclosure, these elements may be referred to in the singular form for ease of discussion.

Also, management system 102, opportunity database 104, online system 106, member database 108, member/opportunity alignment system 120, graphical user interface 130 are shown as separate elements in FIG. 1 for ease of discussion but the illustration is not meant to imply that separation of these elements is required. The illustrated systems (or their functionality) may be divided over any number of physical systems, including a single physical computer system, and can communicate with each other in any appropriate manner.

The illustrative management system 102, online system 106, member database 108, member/opportunity alignment system 120, graphical user interface 130 are communicatively coupled to computing device 160 and to network 140. Portions of management system 102, online system 106, member database 108, member/opportunity alignment system 120, graphical user interface 130 may be implemented as web-based software applications or mobile device applications and hosted by a hosting service (not shown). For example, graphical user interface 130 may be implemented within a front-end portion of management system 102 or within a front-end portion of online system 106, or may be embedded within another application. In an embodiment, portions of graphical user interface 130 are implemented in a web browser that can be executed on computing device 160.

In some embodiments, computing device 160 is a client computing device, such as an end user's smart phone, tablet computer, mobile communication device, wearable device, smart appliance, desktop computer, or laptop machine, and computing device 110 is a server computer or network of server computers located on the Internet, in the cloud. As illustrated in FIG. 1, display device 170 is implemented in computing device 160 but may be implemented as a separate device or as part of another device, or as multiple networked display devices, in other implementations.

The example management system 102 includes management software 40 and opportunity database 104, described above. Opportunity data 52 is stored in and includes a member-specific subset of opportunity database 104. Opportunity database 104 is implemented as a searchable database system, such as a graph-based database system or a table-based relational database system or a hierarchical database system, for example. The opportunity data stored in opportunity database 104 may include numerous data records, where each data record may indicate, for example, a job identifier, a company name, an address, a phone number, a web address, a job title, a job description, a list of required skills.

Online system 106 includes online software 42 and member database 108. Member data 54, described above, is stored in and includes a subset of the data stored in member database 108. Member database 108 is implemented as a searchable data structure, such as a graph-based database system or a relational database system.

Member/opportunity alignment system 120 provides a programmable interface that is coupled to management system 102 and online system 106 via network 140. Portions of member/opportunity alignment software 48, described above, are implemented as part of score computation software 122 of member/opportunity alignment system 120, in an embodiment. Portions of visualization software 50, described above, are implemented as part of presentation layer 124 of member/opportunity alignment system 120, in an embodiment. Presentation layer 124 is server-side software that provides data conversion and data translation services, in an embodiment. Presentation layer 124 facilitates the generation of actionable output 132 that includes alignment scores and/or related information, for presentation by graphical user interface 130, in an embodiment.

Network 140 is an electronic communications network and may be implemented on any medium or mechanism that provides for the exchange of data between the devices that are connected to the network. Examples of network 140 include, without limitation, a network such as a Local Area Network (LAN), Wide Area Network (WAN), Ethernet or the Internet, or one or more terrestrial, satellite or wireless links.

Computing device 160 communicates with display device 170 and operates graphical user interface 130 to establish logical connection(s) over network 140 with portions of management system 102, online system 106, either directly or via member/opportunity alignment system 120. Actionable output 132 is an arrangement of graphical user interface elements, such as an interactive elements and links, in an embodiment. Actionable output 132 can be embedded in an email message or a text message or a web-based application front end or a mobile device application front end, using for example an HTML (Hyper-Text Markup Language) document. In some embodiments, actionable output 132 includes audio output or a combination of audio and visual output. Examples of actionable output 132 are shown in FIGS. 4B and 4C, described below.

Computation of Aggregate Alignment Score

FIG. 2 is flow diagram that depicts a process for computationally aligning heterogenous datasets using data records that are in a one-to-many relationship to produce actionable output, in an embodiment. Process 200 may be performed by a single entity or program or by multiple entities or programs, including for example a browser plug-in and a remote server. The operations of the process as shown in FIG. 2 can be implemented using processor-executable instructions that are stored in computer memory. For purposes of providing a clear example, the operations of FIG. 2 are described as performed by computing device(s) 110, 160, which may be individually or collectively referred to as simply a ‘computing system’. In operation 202, process 200 determines member skills data based on member record obtained from online system. To do this, process 200 receives a data file that contains the member skills data from a data extraction and standardization process, in an embodiment.

In operation 204, process 200 determines job skills data based on job records obtained from management system. To do this, process 200 receives a data file that contains the job skills data from a data extraction and standardization process, in an embodiment. In some embodiments, process 200 assigns weight values to each of the individual job skills in the job skills data, where the weight values are based on frequency of occurrence of the skill, confidence data representing a likelihood that the job skill matches a member skill, and/or other factors.

In an embodiment, the weight values are determined based on source data that is associated with the job skills data. The source data is indicative of a subsection in which the job skills data is located within a job record. Examples of sources include labels of subsections of the job record, such as “Industry,” “Responsibilities” and “Requirements.” Sources that are known or likely to contain structured data are weighted more highly than sources that contain unstructured data, in an embodiment.

In operation 206, process 200 ranks the job skills data based on the weight data, such as the weight values that are associated with the source data within the job records and/or confidence data that is associated with the job skills data. Process 200 sorts the list of weighted skills so that the highest-ranking skills are at the top of the list.

In operation 208, process 200 selects a subset of the job skills data using an adjustable parameter. To do this, process 200 selects the top N skills starting from the top of the skills list, where N is a positive integer, and uses those selected skills to perform the matching operations with the member skills data. The value of N is set by an adjustable parameter, in accordance with the requirements or design of a particular implementation of the system.

In operation 210, process 200 determines alignment data for each pair of member skills data and job skills data, for each instance of job skills data in the subset of the job skills data, using an adjustable matching parameter. To do this, process 200 reads an instance of job skills data and looks for a match in the member skills data, and then repeats the process for all instances of job skills data in the subset of job skills data established by operation 208. In an embodiment, process 200 looks for an exact keyword match between the job skill and the member skill; for example, “Python” matches “Python.”

In other embodiments, process 200 supplements the existing subset of job skills with skills that are (i) inferred based on a rule associated with an instance of job skills data in the existing set of job skills data or (ii) implied based on a semantic interpretation of the instance of job skills data in the existing set of job skills data or a combination of (i) and (ii), and then matches the supplemented list with the member skill data. An example of process 200 inferring a skill based on a rule that is associated with an instance of job skills data is the use of a rule that establishes a dependency relationship between two skills, for example, if skill A is required, then skill B is also required. An example of process 200 implying a skill is the use of a glossary, vocabulary, dictionary, lexicon, ontology, or language model to add synonyms or alternative forms of a skill to the set of job skills data. The adjustable matching parameter is a data that indicates which one(s) of the various approaches to skill matching the system is to use in a particular instance. For example, the adjustable matching parameter may specify that only the exact matching is performed when the source of the skill indicates structured data and that all three forms of matching: exact, inferred, and implied, are performed when the source of the skill indicates unstructured data.

In operation 212, process 200 aggregates the alignment data across all instances of job skills data in the subset of the job skills data to produce an aggregate alignment score for the member data. A detailed example of an aggregation of alignment data is provided in Table 1, below.

TABLE 1
Example of aggregated alignment data.

| Skill Name | Required by Jobs in Set | Possessed by Member |
|---|---|---|
| Java | 1 | 1 |
| Python | ⅔ | 0 |
| Tableau | ⅓ | 0 |
| R | ⅓ | 0 |

In the example of Table 1, there are 3 jobs in the set of job skills data. Job J1 requires Java and Python; Job J2 requires Python, Tableau, and Java, and Job J3 requires R and Java. Assuming equal weighting of the jobs J1-J3, the weight for each job skill is ⅓. Thus, since Java is required by all three of J1, J2, and J3, its total requirement across the entire job set is equal to ⅓*3=1. Similarly, since Python is required by 2 of the three jobs, its total requirement across the entire job set is ⅔. Likewise, the total requirement for each of Tableau and R across the entire job set is ⅓.

In the example of Table 1, only Java was found in the member skill data. Thus, using a similar computation, it is determined that the member possess score is ⅓*3=1 for Java and 0 for each of the other skills. Next, a total aggregate alignment score is computed as: (total member possessed score)/(total job requirements). Using the above example, the computation is 1/(1+⅔+⅓+⅓)= 3/7. The top ranked job skill that is missing from the member skill set is Python, followed by Tableau and R. The aggregate alignment score produces actionable output in that it identifies particular skills that the member needs to acquire if the member is interested in pursuing the jobs in the identified group of jobs.

Example of Heterogenous Data Sets

FIG. 3 is an example entity relationship diagram showing a member data record having a one to many relationship with opportunity data records. FIG. 3 includes examples of skills data within a member data record 302, which includes both structured data (“Skills”) and unstructured data (“Description”). FIG. 3 also includes examples of skills data within a job data record 304, and identifies examples of sources 306, 308 of skills data within an opportunity data record. As described above, weight data can be associated with sources 306, 308. The data records 302, 304 are heterogenous in that they are implemented using different schema. For example, member data record 302 includes a Skills section that contains structured data, while job data record 304 contains a Requirements section that contains unstructured data.

Examples of Actionable Output

FIGS. 4A, 4B, and 4C are screen captures of examples of actionable output, in an embodiment. Output 400, 410, 420 are designed to be displayed in graphical user interface 130, in an embodiment. In FIG. 4A, the screen capture 400 includes a search query input box 402 and activity data 404 (search history data), and recommendation data 406 (based on interaction history). Screen capture 400 is an example user interface through which member interactions may initiate the operation of the skill alignment functionality disclosed herein.

FIG. 4B is a screen capture 410 of a user interface that is generated as a result of the skill alignment computations described above. Screen capture 410 displays the aggregate alignment score (75) for a member who is currently a Chemist with a job category of Data Science. A graphical element 414 represents the degree to which a particular skill is required by the jobs in the Data Science set of jobs, in the aggregate. The graphical elements 412 represents the degree to which the member possesses each of those particular required skills. Together, when elements 412 are overlaid on elements 414, the arrangement of elements illustrates the mismatch between the member skills and the job skills. Graphical element 416 illustrates one approach for highlighting the skills that the member most needs to obtain in order to be able to perform the jobs.

FIG. 4C is similar to FIG. 4B. Screen capture 420 displays the aggregate alignment score (32) for a member who is currently a Computer Scientist with a job category of Data Science. A graphical element 424 represents the degree to which a particular skill is required by the jobs in the Data Science set of jobs, in the aggregate. A graphical element 422 represents the degree to which the member possesses each of those particular required skills. Together, when elements 422 are overlaid on elements 420, the arrangement of elements illustrates the mismatch between the member skills and the job skills. Graphical element 426 illustrates one approach for highlighting the skills that the member most needs to obtain in order to be able to perform the jobs. The aggregate alignment score is lower in FIG. 4C than in FIG. 4B because there are fewer mismatched skills in FIG. 4C than in FIG. 4B. Thus, in the illustration, a low aggregate alignment score is indicative of a high degree of skill alignment while a high aggregate alignment score indicates a greater need for skill development. In other embodiments, a higher alignment score corresponds to a high degree of alignment between the member skills data and the job skills data. Any of the graphical elements in FIGS. 4B and 4C can be configured to be actionable, for example using embedded hyperlinks. For example, an interaction selecting element 426 can initiate a course recommendation process that generates online training recommendations in the skill areas identified as lacking.

It should be noted that the aggregate alignment score and actionable outputs are dynamic. That is, as member data records and job records are updated with new skills and other information, the aggregate alignment score and corresponding actionable output changes automatically as well.

### BENEFITS

Benefits that may be realized by at least some embodiments described herein include improving the effectiveness of opportunity recommendations provided by management software. Using the disclosed approaches, opportunity recommendations are robust to attempts to ‘game the system’ with specially manipulated or engineered data sets. More generally, the disclosed approaches facilitate enhanced cooperation between management systems and online systems through the incorporation of the above-described computational alignment processes.

### Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

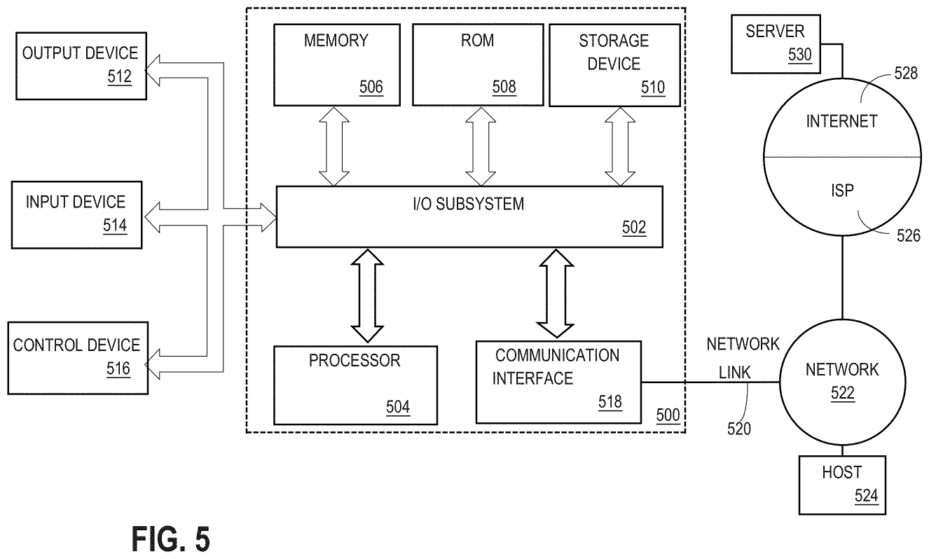

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### ADDITIONAL EXAMPLES

Illustrative examples of the technologies disclosed herein are provided below. An embodiment of the technologies may include any of the examples or a combination of the described below.

In an example 1, a method includes determining job category data based on a member interaction with a management system, wherein the member interaction results in a first output; pairing a member data record obtained from an online system with each job record in a group of job records obtained from the management system to produce a set of member-job pairs, wherein the group of job records is determined based on the job category data; calculating an aggregate alignment score over the set of member-job pairs using member skills data extracted from the member data record and job skills data extracted from the group of job records, wherein the aggregate alignment score is a measure of a mismatch between the member skills data and the job skills data; based on the aggregate alignment score, generating a second output that replaces or modifies or supplements the first output with output that is actionable to address the mismatch between the member skills data and the job skills data; wherein the method is performed by one or more computing devices.

An example 2 includes the method of example 1, and includes matching job skills data extracted from the group of job records with member skills data extracted from the member data record using an adjustable parameter and supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii). An example 3 includes the method of example 1 or example 2, and includes matching job skills data extracted from the group of job records with member skills data extracted from the member data record, and based on an adjustable parameter, adjusting a number of instances of job skills data used to perform the matching. An example 4 includes the method of any of examples 1-3, for each job record in the group of job records, ranking individual skills within the job record according to weight data that is determined based on source data that is associated with the individual skills. An example 5 includes the method of example 2, and includes, for each job record in the group of job records, boosting a ranking of an individual skill within the job record when the individual skill matches an instance of the member skills data. An example 6 includes the method of any of examples 1-5, and includes causing output of a visualization of at least the aggregate alignment score in a digital presentation that is accessible by a user of the management system. An example 7 includes the method of any of examples 1-6, wherein the second output comprises a plurality of graphical elements that are arranged to illustrate the mismatch between the member skills data and the job skills data.

In an example 8, a system includes one or more computer processors; an alignment system coupled to the one or more computer processors, wherein the alignment system performs operations comprising: determining job category data based on a member interaction with a management system, wherein the member interaction results in a first output; pairing a member data record obtained from an online system with each job record in a group of job records obtained from the management system to produce a set of member-job pairs, wherein the group of job records is determined based on the job category data; calculating an aggregate alignment score over the set of member-job pairs using member skills data extracted from the member data record and job skills data extracted from the group of job records, wherein the aggregate alignment score is a measure of a mismatch between the member skills data and the job skills data; based on the aggregate alignment score, generating a second output that replaces or modifies or supplements the first output with output that is actionable to address the mismatch between the member skills data and the job skills data.

An example 9 includes the system of example 8, wherein the alignment system performs operations comprising matching job skills data extracted from the group of job records with member skills data extracted from the member data record using an adjustable parameter. An example 10 includes the system of example 8 or example 9, wherein the alignment system performs operations comprising matching job skills data extracted from the group of job records with member skills data extracted from the member data record, and based on an adjustable parameter, adjusting a number of instances of job skills data used to perform the matching. An example 11 includes the system of any of examples 8-10, wherein the alignment system performs operations comprising, for each job record in the group of job records, ranking individual skills within the job record according to weight data that is determined based on source data that is associated with the individual skills. An example 12 includes the system of any of examples 8-11, wherein the alignment system performs operations comprising supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii). An example 13 includes the system of any of examples 8-12, wherein the alignment system performs operations comprising, for each job record in the group of job records, boosting a ranking of an individual skill within the job record when the individual skill matches an instance of the member skills data. An example 14 includes the system of any of examples 8-13, wherein the alignment system performs operations comprising causing output of a visualization of at least the aggregate alignment score in a digital presentation that is accessible by a user of the management system, wherein the second output comprises a plurality of graphical elements that are arranged to illustrate the mismatch between the member skills data and the job skills data.

In an example 15, a computer program product includes one or more non-transitory computer-readable storage media comprising instructions which, when executed by one or more processors, cause: determining job category data based on a member interaction with a management system, wherein the member interaction results in a first output; pairing a member data record obtained from an online system with each job record in a group of job records obtained from the management system to produce a set of member-job pairs, wherein the group of job records is determined based on the job category data; calculating an aggregate alignment score over the set of member-job pairs using member skills data extracted from the member data record and job skills data extracted from the group of job records, wherein the aggregate alignment score is a measure of a mismatch between the member skills data and the job skills data; based on the aggregate alignment score, generating a second output that replaces or modifies or supplements the first output with output that is actionable to address the mismatch between the member skills data and the job skills data.

An example 16 includes the computer program product of example 15, wherein the instructions, when executed by the one or more processors, cause matching job skills data extracted from the group of job records with member skills data extracted from the member data record, and based on an adjustable parameter, adjusting a number of instances of job skills data used to perform the matching. An example 17 includes the computer program product of example 15 or example 16, wherein the instructions, when executed by the one or more processors, cause, for each job record in the group of job records, ranking individual skills within the job record according to weight data that is determined based on source data that is associated with the individual skills. An example 18 includes the computer program product of any of examples 15-17, wherein the instructions, when executed by the one or more processors, cause supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii). An example 19 includes the computer program product of any of examples 15-18, wherein the instructions, when executed by the one or more processors, cause, for each job record in the group of job records, boosting a ranking of an individual skill within the job record when the individual skill matches an instance of the member skills data. An example 20 includes the computer program product of any of examples 15-19, wherein the instructions, when executed by the one or more processors, cause outputting of a visualization of at least the aggregate alignment score in a digital presentation that is accessible by a user of the management system, wherein the second output comprises a plurality of graphical elements that are arranged to illustrate the mismatch between the member skills data and the job skills data.

### GENERAL CONSIDERATIONS

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
determining job category data based on a member interaction with a management system, wherein the member interaction results in a first output;
pairing a member data record obtained from an online system with each job record in a group of job records obtained from the management system to produce a set of member-job pairs, wherein the group of job records is determined based on the job category data;
calculating an aggregate alignment score over the set of member-job pairs using member skills data extracted from the member data record and job skills data extracted from the group of job records, wherein the aggregate alignment score is a measure of a mismatch between the member skills data and the job skills data;
based on the aggregate alignment score, generating a second output that replaces or modifies or supplements the first output with output that is actionable to address the mismatch between the member skills data and the job skills data;
wherein the method is performed by one or more computing devices.

2. The method of claim 1, further comprising matching job skills data extracted from the group of job records with member skills data extracted from the member data record using an adjustable parameter; and supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii).

3. The method of claim 1, comprising matching job skills data extracted from the group of job records with member skills data extracted from the member data record, and based on an adjustable parameter, adjusting a number of instances of job skills data used to perform the matching.

4. The method of claim 2, further comprising, for each job record in the group of job records, ranking individual skills within the job record according to weight data that is determined based on source data that is associated with the individual skills.

5. The method of claim 2, further comprising, for each job record in the group of job records, boosting a ranking of an individual skill within the job record when the individual skill matches an instance of the member skills data.

6. The method of claim 1, further comprising causing output of a visualization of at least the aggregate alignment score in a digital presentation that is accessible by a user of the management system.

7. The method of claim 1, wherein the second output comprises a plurality of graphical elements that are arranged to illustrate the mismatch between the member skills data and the job skills data.

8. A system comprising:
one or more computer processors;
an alignment system coupled to the one or more computer processors, wherein the alignment system performs operations comprising:
determining job category data based on a member interaction with a management system, wherein the member interaction results in a first output;
pairing a member data record obtained from an online system with each job record in a group of job records obtained from the management system to produce a set of member-job pairs, wherein the group of job records is determined based on the job category data;
calculating an aggregate alignment score over the set of member-job pairs using member skills data extracted from the member data record and job skills data extracted from the group of job records, wherein the aggregate alignment score is a measure of a mismatch between the member skills data and the job skills data;
based on the aggregate alignment score, generating a second output that replaces or modifies or supplements the first output with output that is actionable to address the mismatch between the member skills data and the job skills data.

9. The system of claim 8, wherein the alignment system performs operations comprising matching job skills data extracted from the group of job records with member skills data extracted from the member data record using an adjustable parameter.

10. The system of claim 8, wherein the alignment system performs operations comprising matching job skills data extracted from the group of job records with member skills data extracted from the member data record, and based on an adjustable parameter, adjusting a number of instances of job skills data used to perform the matching.

11. The system of claim 8, wherein the alignment system performs operations comprising, for each job record in the group of job records, ranking individual skills within the job record according to weight data that is determined based on source data that is associated with the individual skills.

12. The system of claim 8, wherein the alignment system performs operations comprising supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii).

13. The system of claim 8, wherein the alignment system performs operations comprising, for each job record in the group of job records, boosting a ranking of an individual skill within the job record when the individual skill matches an instance of the member skills data.

14. The system of claim 8, wherein the alignment system performs operations comprising causing output of a visualization of at least the aggregate alignment score in a digital presentation that is accessible by a user of the management system, wherein the second output comprises a plurality of graphical elements that are arranged to illustrate the mismatch between the member skills data and the job skills data.

15. A computer program product comprising:
one or more non-transitory computer-readable storage media comprising instructions which, when executed by one or more processors, cause:
determining job category data based on a member interaction with a management system, wherein the member interaction results in a first output;
pairing a member data record obtained from an online system with each job record in a group of job records obtained from the management system to produce a set of member-job pairs, wherein the group of job records is determined based on the job category data;
calculating an aggregate alignment score over the set of member-job pairs using member skills data extracted from the member data record and job skills data extracted from the group of job records, wherein the aggregate alignment score is a measure of a mismatch between the member skills data and the job skills data;
based on the aggregate alignment score, generating a second output that replaces or modifies or supplements the first output with output that is actionable to address the mismatch between the member skills data and the job skills data.

16. The computer program product of claim 15, wherein the instructions, when executed by the one or more processors, cause matching job skills data extracted from the group of job records with member skills data extracted from the member data record, and based on an adjustable parameter, adjusting a number of instances of job skills data used to perform the matching.

17. The computer program product of claim 15, wherein the instructions, when executed by the one or more processors, cause, for each job record in the group of job records, ranking individual skills within the job record according to weight data that is determined based on source data that is associated with the individual skills.

18. The computer program product of claim 15, wherein the instructions, when executed by the one or more processors, cause supplementing an existing set of the job skills data with skills data that is (i) inferred based on a rule associated with an instance of job skills data in the existing set of job skills data or (ii) implied based on a semantic interpretation of the instance of job skills data in the existing set of job skills data, or a combination of (i) and (ii).

19. The computer program product of claim 15, wherein the instructions, when executed by the one or more processors, cause, for each job record in the group of job records, boosting a ranking of an individual skill within the job record when the individual skill matches an instance of the member skills data.

20. The computer program product of claim 15, wherein the instructions, when executed by the one or more processors, cause outputting of a visualization of at least the aggregate alignment score in a digital presentation that is accessible by a user of the management system, wherein the second output comprises a plurality of graphical elements that are arranged to illustrate the mismatch between the member skills data and the job skills data.
